(19) United States
(12) Patent Application Publication
(10) Pub. No.: US 2023/0280808 A1
(43) Pub. Date: Sep. 7, 2023

(54) SOFTWARE-DEFINED ENERGY STORAGE SYSTEM INTERFACE

(71) Applicant: REON Technology, Inc., Chelmsford, MA (US)

(72) Inventors: Tiegeng Ren, Westford, MA (US); Xuanhang Zhang, Austin, TX (US)

(73) Assignee: REON Technology, Inc., Chelmsford, MA (US)

(21) Appl. No.: 18/115,811

(22) Filed: Mar. 1, 2023

Related U.S. Application Data
(60) Provisional application No. 63/334,106, filed on Apr. 23, 2022.
(60) Provisional application No. 63/315,550, filed on Mar. 2, 2022.
(60) Provisional application No. 63/333,708, filed on Apr. 22, 2022.
(60) Provisional application No. 63/334,160, filed on Apr. 24, 2022.

(51) Int. Cl. G06F 1/26

(52) U.S. Cl. CPC G06F 1/263

(57) ABSTRACT

Techniques for a software-defined energy storage system interface are disclosed. A battery system, comprised of columns of battery cells connected in series by software-controlled switches wherein columns are connected in parallel by additional software-controlled switches, is accessed. Information about the battery system is obtained. The information is provided through a software Application Programming Interface (API) which provides an Industrial Internet of Things (IIoT) capability. The API can also receive queries and power requests for the battery system. A battery system configuration is defined to provide an energy profile based on a power request. The battery system is reconfigured based on the configuration that was defined. The battery system is subsequently reconfigured dynamically based on the power request as the battery cells within the system discharge or change status. Configurations can be predefined and can include different voltage arrangements for charging than for discharging.

### RELATED APPLICATIONS

This application claims the benefit of U.S. provisional patent applications “Software-Defined Energy Storage System Interface” Ser. No. 63/334,106, filed Apr. 23, 2022, “Battery System Management Using Cell State” Ser. No. 63/333,708, filed Apr. 22, 2022, “Battery Performance Tracking Across Battery Cells” Ser. No. 63/334,160, filed Apr. 24, 2022, and “Dynamic Control Of A Disparate Battery System” Ser. No. 63/315,550, filed Mar. 2, 2022.

Each of the foregoing applications is hereby incorporated by reference in its entirety.

### FIELD OF ART

This application relates generally to battery management and more particularly to a software-defined energy storage system interface.

### BACKGROUND

Batteries are used by people around the world to store and provide electrical energy. The batteries are used to start or power vehicles such as cars, trucks, and buses; and to power personal vehicles such as hoverboards and bicycles; to name only a few uses with respect to transportation. The batteries are also used to provide illumination, to power personal electronic devices such as phones, and even to supply power to games and toys. The batteries can be part of an electrical power infrastructure, storing energy from renewable power sources such as solar and wind sources, so that electrical power can be provided even in the absence of sunshine or wind. The batteries can range from relatively simple and inexpensive items to highly complex and expensive ones. Differences between low-cost batteries and expensive batteries can include storage chemistries, the amounts of electrical energy that can be stored, the sizes and weights of the batteries themselves, and the ease of using them. Some batteries are widely available and can be easily obtained at a relatively low cost. These batteries include single use batteries and common rechargeable batteries, and are extensively used in flashlights, radios, and handheld gaming devices. Other batteries, such as more sophisticated chemistry rechargeable batteries, are used in equipment that requires lightweight and longer battery usage time. These batteries are used in personal electronic devices such as smartphones, tablets, and laptop computers. Lighter, higher energy density batteries are also highly desirable for transportation applications as vehicle manufacturers seek to improve the effective ranges of their vehicles. Whatever the applications, batteries are likely to remain the primary electrical energy storage technology for some time to come.

The proliferation of batteries has been a major force for improving quality of life. Batteries are ubiquitous, enabling everyday devices that many now simply take for granted. This expansion is evident in the broad use of a wide array of personal electronic devices. For years, analog watches have relied on small, disposable batteries to facilitate timekeeping. Today, rechargeable batteries have enabled a new set of digital watches with connectivity to cell phones, computers, and the like. Cell phones themselves, allowing literally billions of users to stay in contact with friends, loved ones, etc., would not be possible without advanced battery technology. Batteries have made a lasting impact on the computer industry as well. Laptop computers have overtaken desktops in sales as the desire for portable computing has risen. Now, computers can be used for work or play just about anywhere—in airports, on planes, in coffee shops, or while sitting on the couch at home. Beyond electronic devices, batteries play critical roles for everyday life. At home, disposable batteries are everywhere—in flashlights, clocks, grill starters, remote controls, etc. Batteries also play a role in safety. For example, battery-powered candles that create ambiance without a flame can now be purchased. Smoke detectors include battery back-ups. And practically all public buildings in the United States are required to have lighted exit signs, highlighting the path to safety in case of a fire or emergency. Batteries ensure that these signs glow brightly, even if the building loses power. Likewise, battery-powered safety equipment can be found on vehicles and inside homes. As technology advances, there is no question that batteries will continue to play a central role in enabling new applications, increasing mobility, and keeping us safe.

### SUMMARY

The concerns over climate change have encouraged modifications in consumer and business behavior. Today, these changes can be seen across a broad number of industries as the three R's—reduce, reuse, recycle—have become guiding principles. For example, many states now require businesses and private citizens to separate recyclable waste from what goes to a landfill. Consumer interest in shopping secondhand stores has grown to help conserve materials. Reusable plastic and steel water bottles are popular alternatives to disposable water bottles or plastic cups. Many restaurants have replaced plastic straws with paper or washable steel straws. While these and other changes have been noticeable, the desire to reduce carbon emissions has taken center stage in environmental conversations. No industry has received more pressure to reduce carbon emissions than automobile manufacturers. While improving gas mileage has traditionally been a focus of the industry, recent technological advancements have made possible hybrid, hybrid plug-in, and fully electric vehicles which go further to reduce emissions. At the same time, the increase in these electrically powered vehicles has caused an increase in used batteries which contain hazardous materials. Power generation and electronic devices of all types have the unintended consequence of producing used batteries, adding to the problem of environmental pollution.

Disclosed herein is a software-defined energy storage system interface. A plurality of used battery cells can be reused in combination with software-controlled switches. The switches can combine the used battery cells into columns made up of cells in series. The columns can be arranged in parallel by additional software-controlled switches, creating a battery system which is able to provide power for homes, businesses, equipment, etc. The battery cells can be scanned to collect performance information including temperature, temperature rate-of-change, current, voltage, voltage rate-of-change, or impedance data, and so on. The performance information can be collected while the batteries are in use. The battery cells can be selected when in use by the battery system or for recharging, or deselected when the cell is unneeded in a particular battery configuration or when the cell is inadequate to the task. Frequent monitoring of the cells can detect problems with one or more cells, such as overheating, a short circuit, etc. Thus, problematic cells can be quickly removed from service and safely discharged, thereby reducing or eliminating the risk of fire or explosion.

An application programming interface (API) can be provided which provides a software interface to the battery system. The interface can provide performance information to a user; query capabilities of the battery system; determine the availability of output of the system; associate cost information with battery information; and deliver power requirements to the battery system, including voltage, temperature, duration, safety parameters, and so on. A battery system configuration can be defined based on power requirements which also takes into consideration the voltage, age, availability, safety, current capacity, etc. of the battery cells in the system. The battery system can then negotiate subsequent configurations based on power requirements and ongoing battery information. These subsequent configurations can be accomplished during runtime.

A processor-implemented method for energy storage is disclosed comprising: accessing a battery system comprising a plurality of battery cells, wherein the plurality of battery cells and a plurality of software-controlled switches comprise a plurality of battery columns made up of battery cells arranged in series using the software-controlled switches, wherein the plurality of battery columns is connected in parallel using the software-controlled switches; obtaining information on the battery system; providing the information on the battery system through a software interface; receiving a set of power request parameters through the software interface; defining a configuration for the battery system based on the power request parameters and the information on the battery system; and reconfiguring the battery system, based on the configuration for the battery system that was defined. In embodiments, the reconfiguring is accomplished using the software-controlled switches within the battery system. In embodiments, the software interface comprises an application program interface (API). In embodiments, the plurality of software-controlled switches comprises a crossbar switch.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1A is a flow diagram for a software-defined energy storage system interface.

FIG. 1B is a block diagram showing API communication.

FIG. 2A illustrates columns of battery cells and switches in a battery system.

FIG. 2B is a flow diagram for battery system control.

FIG. 3 is a system block diagram for battery system management.

FIG. 4A illustrates example battery units.

FIG. 4B illustrates multiple battery unit configurations.

FIG. 5 is a system schematic diagram for battery management.

FIG. 6 is a system diagram for battery system management using cell state.

### DETAILED DESCRIPTION

Software can be used to control and define an energy storage system. A multitude of switches within such an energy storage system can be controlled through a software interface. These switches can configure the energy storage system as needed. Such an energy storage system can be comprised of batteries of various types. One can hardly go through a single day without relying on rechargeable batteries. Some uses of these batteries are easy to see. For example, every portable electronic device such as a cell phone, laptop computer, tablet, and so on, contains a rechargeable battery. Further, the rise in popularity of hybrid, hybrid plug-in, and fully electric vehicles has expanded reliance on larger rechargeable batteries. Some uses of these batteries are found behind the scenes. For example, renewable energy storage systems use large batteries to provide power to power grids when renewable sources are offline. Seen or unseen, all rechargeable batteries age over time, primarily due to charge/discharge cycling. At some point, the battery systems are unable to meet the technical specifications intended by the manufacturer and the batteries require replacement. Unfortunately, this poses significant problems for the environment. For example, additional lithium must be mined, a process which consumes massive amounts of water, harms the soil, and causes air contamination. Further, batteries that have been removed from equipment can start fires if not stored properly. New ways of reducing waste and reusing existing batteries are needed, especially as the use of larger rechargeable batteries increases.

The disclosed method for a software-defined energy storage system interface can be an effective method to control and deliver power as needed. In some cases, the energy storage system can include and reuse existing batteries and thereby reduce old battery waste. Rechargeable batteries that are removed from service can be provided a “second life”. They can be scanned to collect performance information and to determine usability and capacity. New power applications can use the batteries by adding software-controlled switches to select or deselect the cells. The battery cells can be selected when in use by the battery system or for recharging, or deselected when the cell is unneeded or inadequate for a particular battery configuration. Scanners or sensors can also be added to the cells to monitor cell voltage, cycles, “health”, and so on. Frequent monitoring of the cells can detect problems with one or more cells, such as overheating, a short circuit, etc. Thus, problematic cells can be quickly removed from service and safely discharged, thereby reducing or eliminating the risk of fire or explosion.

The battery cells can be assembled into a disparate battery system comprising a plurality of battery cells. The cells and a plurality of software-controlled switches can comprise battery columns containing battery cells coupled in series. The columns can be connected in parallel using additional software-controlled switches. The disparate battery system can include rechargeable batteries such as lithium-ion batteries that have been removed from vehicles, energy storage devices, personal electronic devices, and so on. These batteries can be considered used, previously used, preowned, “second life”, second hand, or can be described with some other terminology denoting a second usage. Battery cell profiles can be used to store information about the battery cells. Information can be obtained from the battery system, including scanning the battery cells to collect performance information such as temperature, temperature rate-of-change, current, voltage, voltage rate-of-change, impedance data, number of cycles, and so on. Software access to the battery system can be provided through a software Application Programming Interface (API) which can also enable an Industrial Internet of Things (IIoT) capability. Queries, such as capability of the battery system, availability of output, and so on, can be made through the API interface. Likewise, requests can be made of the battery system through the API interface, such as a power request with parameters which can include voltage requirements; power requirements; changing direction of current flow to charge or discharge the battery cells, columns, system, etc.; changing the voltage output of the system; balancing energy storage between multiple battery systems; responding to a power grid demand; and so on. The battery system can be reconfigured by the software-controlled switches within the battery system. The software-controlled switches can be controlled by the software API interface. The reconfiguration can be requested by a user, an external system, and so on. The reconfiguration can also be achieved dynamically in response to a user request; a battery cell, column, or system failure; balancing energy storage between battery cells, columns, systems, etc.; a voltage level, temperature, current, etc.; above or beyond a threshold, including a rate-of-change threshold; storage capacity; and so on.

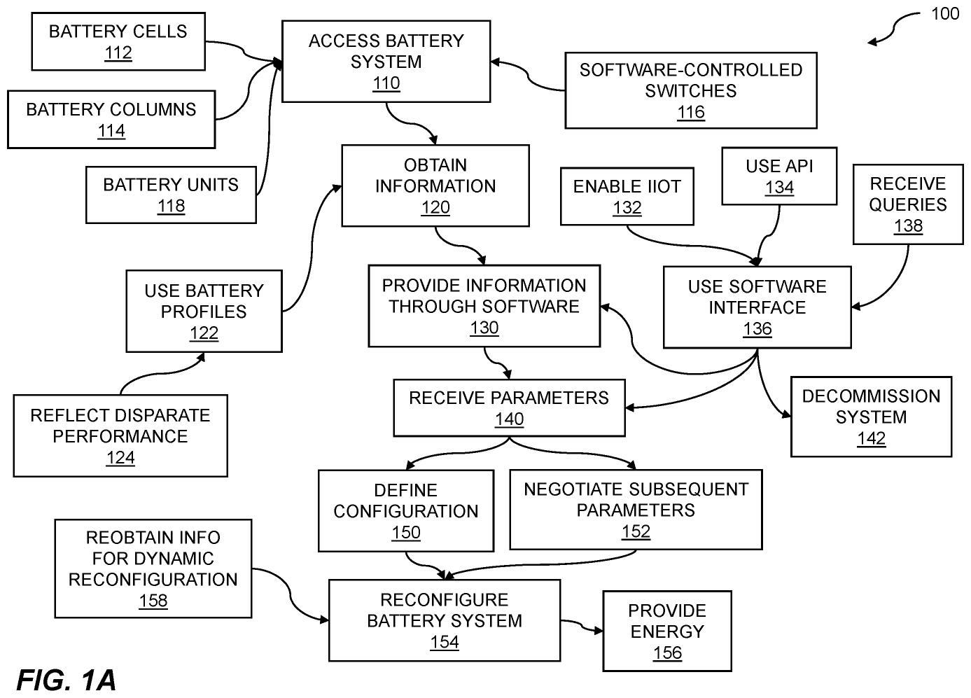

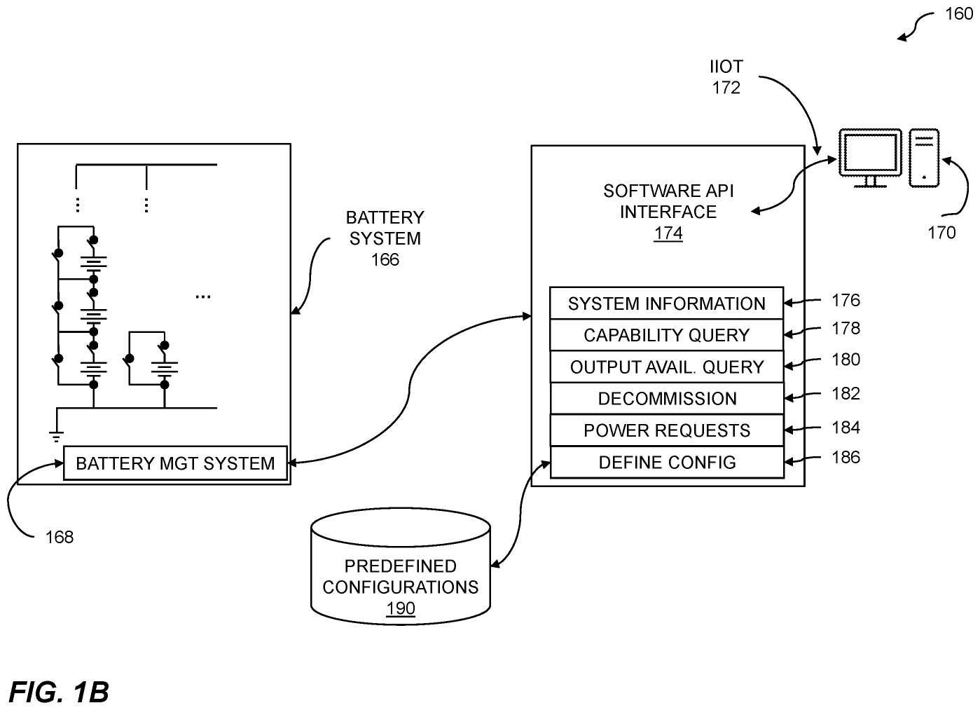

FIG. 1A is a flow diagram for a software-defined energy storage system interface. A battery system can be accessed. In embodiments, the battery system is comprised of any combination of new or used battery cells coupled by software-controlled switches. The switches can configure the battery cells into columns of cells connected in series. The switches can also connect the columns in parallel to comprise the battery system. Information can be obtained on the battery system including battery cell profile, safety information, temperature, current, voltage, impedance, and so on. Information on the battery system can be provided through a software interface. The interface, which can be provided as an application programming interface (API), can receive power request parameters from the user. The battery system can define a configuration based on the power request parameters and can reconfigure the software-controlled switches to match the desired configuration.

The flow 100 includes accessing 110 a battery system, comprising a plurality of battery cells wherein the plurality of battery cells and a plurality of software-controlled switches comprise a plurality of battery columns made up of battery cells arranged in series using the software-controlled switches wherein the plurality of battery columns is connected in parallel using the software-controlled switches. The battery cells 112 can include rechargeable batteries such as lithium-ion batteries that have been removed from vehicles, energy storage devices, personal electronic devices, and so on. These batteries can be considered used, previously used, preowned, “second life”, etc. In embodiments, the plurality of battery cells includes lithium-ion battery cells. Other types of rechargeable cells, such as sealed lead-acid (SLA), nickel-cadmium (NiCd), nickel-metal hydride (NiMH), lithium-polymer (LiPo), lithium-iron-phosphate (LiFePO4), solid-state, sodium ion, zinc based, etc., can be included. The battery cells may include battery profiles. The battery cell profile can include a variety of information associated with a battery cell including information on aging, brand, or specification. In embodiments, the profiles include manufacturing date; batch number; serial number; in-service date; removed-from-service date; notations about observed wear, cracks, or damage; etc. The profiles can be uploaded by a user, downloaded from a library or repository, and so on. The profiles can be determined while the battery system is in use. The software-controlled switches 116 can be coupled to the battery cells to create battery columns 114. The battery columns can include one or more battery cells in series and the battery columns themselves may be connected in parallel by the software-controlled switches. The software-controlled switches can comprise a crossbar switch. Smart switches can be employed in the battery system. In embodiments, the plurality of battery cells is grouped into battery units 118. The battery units can comprise a battery column. A battery unit can contain one or more battery cells. Each battery cell can have a variety of profiles, which can include a battery cell level, a battery column level, or a battery unit level. The battery profiles can be used to determine whether a battery unit requires bypassing reconfiguration (discussed below), recharging, replacement, etc. The battery profiles can be updated. In embodiments, the battery profiles can be updated on any regular time interval. The regular time interval can include one or more milliseconds, seconds, and so on. In embodiments, the analyzing the battery units to determine usability and capacity can be performed on a periodic basis. The periodic basis can include one or more milliseconds, seconds, etc.

The flow 100 includes obtaining information 120 on the battery system. The obtaining information can include scanning the battery cells to collect performance information such as temperature, current, voltage, impedance, number of cycles, and so on. The performance information can be evaluated at various levels including a battery cell, a battery column, the battery system, etc. and can be collected while the battery cells, columns, units, system, etc. are in use. Obtaining information can be accomplished by software-controlled switches, smart switches, scanners, sensors, etc. and can be added to the cells to monitor cell “health”, and so on. In embodiments, the information is collected at start up or in run time. The obtaining information can be based on using battery cell profiles 122. The battery profiles can be based on manufacturer specifications, acceptance testing, in situ system testing, collected sensor information, specified or collected electrical characteristics, specified or collected physical characteristics, and so on. The battery profiles can reflect disparate battery performance 124. For example, rechargeable batteries such as lithium-ion batteries that have been removed from vehicles, energy storage devices, personal electronic devices, and so on can be reused for other applications. These batteries can be considered used, previously used, preowned, “second life”, second hand, or referenced by some other terminology denoting a second usage. Such batteries can be perfectly capable of functioning in certain capacities and usages. While the batteries may no longer meet their original specifications with respect to energy storage, leakage, and so on, the batteries can still store and provide energy. In order to use such “second life” batteries, the batteries can be disassembled down to their battery cells. Switches and scanners or sensors can be coupled to the battery cells. The switches can be used to couple, decouple, and bypass the battery cells, while the scanners and sensors can be used to monitor battery performance information such as temperature, temperature rate-of-change, current, voltage, voltage rate-of-change, or impedance data. The switches, which are based on high-speed switching devices, and the scanners can be controlled in order to operate the battery cells, battery units, and battery systems at their most efficient and safest levels. The safe battery levels can be monitored by a failsafe system that monitors safe battery levels and selectively disconnects battery units from the battery system before a battery unit failure. The battery cells, units, and systems can be monitored frequently in order to quickly respond to any detected problems. The monitoring and response enable dynamic control. Furthermore, newly manufactured batteries, even from the same manufacturer, can have different usage characteristics and therefore different profiles. Thus, new batteries, new batteries with reduced specifications, reused batteries, etc. can each have disparate performance and require different profiles.

The flow 100 can include providing the information on the battery system through a software interface 130. By using the software interface 136, a user can read parameters from the battery cells, columns, system, etc., or can write parameters to the battery cells, column, system, etc. The software interface can receive queries 138 from a user, an external system, etc., and can provide information in response such as temperature, temperature rate-of-change, current, voltage, voltage rate-of-change, impedance data, and so on. In embodiments, queries include capabilities of the battery system, availability of output, and so on. The software interface can comprise an application programming interface (API) 134 and can include communications over an industrial grade communication hardware standardized interface such as CAN, RS-485, EtherCAT, Modbus, etc. The software interface can also enable an Industrial Internet of Things (IIoT) 132 capability for the battery system. In embodiments, the software interface can be used to decommission the system 142. In some embodiments, a portion of the system can be decommissioned as warranted, based on information on the system as a whole and portions thereof.

The flow 100 can include receiving a set of power request parameters 140 through the software interface. The power request parameters can include changing the direction of current flow to charge or discharge the battery cells, columns, system, etc.; changing the voltage output of the system; balancing energy storage between multiple battery systems; responding to a power grid demand; and so on. The power request parameters can also include voltage, power, total energy, external system operating requirements, internal system operating requirements, user settings, user preferences, and so on.

The flow 100 can include defining a configuration 150 for the battery system based on the power request parameters. The configuration of battery cells and columns within the system can be controlled by the user, an external system, etc. to achieve the power request parameters. In embodiments, adjustments can be accomplished dynamically. The system configuration can include an inverter to convert the DC voltage associated with the battery system to AC voltage. In some embodiments, the system configuration can include a DC-to-DC converter.

The flow 100 can include reconfiguring the battery system 154. The reconfiguring can be accomplished by the software-controlled switches within the battery system. The software-controlled switches can be controlled by the software interface to achieve the reconfiguration for the battery system that was defined. The reconfiguration request can be initiated in response to a user request; an external system request; a battery cell, column or system failure; balancing energy storage between battery cells, columns, systems, etc.; a voltage level, temperature, current, etc. above or beyond a threshold; storage capacity; and so on. The reconfiguring can include a different voltage arrangement for charging than a voltage arrangement for discharging. The reconfiguring can adjust the voltage down for charging to, for example, 40V, 50V, and so on. Likewise, the reconfiguring can increase the battery system voltage for providing energy to, for example, 600V, 900V, and so on. The reconfiguring can be accomplished dynamically. A built-in electrical design to smooth voltage and current spikes can be provided within the software-controlled switches to avoid damage to appliances. The reconfiguration can be based on negotiating subsequent power parameters 152, using one or more processors, based on the set of power request parameters received and the information on the battery system. The negotiating can be accomplished during run time. The negotiating can be based on a target voltage, current, duration, safety factors, a predefined voltage such as 48 volts, 80 volts, 120 volts, 480 volts, 800 volts, 1000 volts, or some other voltage, etc. The negotiating can be in response to changes in battery unit voltages as the battery units discharge.

The flow 100 can include providing energy 156. The battery system can provide energy to power grids, buildings, such as a condominium complex or a strip mall, charging stations, and so on. The battery system can provide primary or back-up power. The providing energy from the battery system can be based on the reconfiguring and part of a contractual energy arrangement. A cost can be associated with providing power based on information provided through the software interface. The cost can be queried by the user, an external system, etc. which is requesting energy from the battery system. The flow 100 can include reobtaining information for dynamic reconfiguration 158. The information can be obtained initially, from scanning, from profiles, from sensors, etc. and then reobtained periodically. The reobtaining can be repeated after a specified interval of time, which can enable defining a new configuration, which can then be used to dynamically reconfigure the battery system. The reobtaining interval can include one or more milliseconds, one or more seconds, etc. The reobtaining interval frequency can be based on safety factors such as detecting battery overheating, battery failure, and so on. The choice of the reobtaining interval frequency can be chosen based on the type or types of batteries associated with a battery system. The reobtaining can be enabled through the API. Some embodiments comprise reobtaining information on the battery system periodically. In embodiments, the information that was reobtained enables dynamic reconfiguring of the battery system.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

FIG. 1B is a block diagram showing API communication arrangement 160. An API can be provided to interface to the battery system through a hardware communication interface. The API can include commands such as power requests, system information, configuration definition, decommissioning a part of the battery system, querying the battery system for capability or output availability, and so on. The API can enable an Industrial Internet of Things (IIoT) protocol. Predefined queries can be saved, downloaded, uploaded, etc. A Battery Management System (BMS) can determine the system configuration based on power requests to the system. The requests can be made by a user or automatically by a system requiring energy. The BMS can determine how to direct the software-controlled switches to couple specific battery cells to achieve the desired configuration and can provide battery system information using secure TCP/IP protocols.

The arrangement 160 can include a battery system 166. The battery system is comprised of a plurality of battery cells. The battery cells are coupled to a plurality of software-controlled switches. The switches can couple the battery cells into a plurality of columns arranged in series. The switches can couple the columns in parallel, forming the battery system. The battery cells can include rechargeable batteries such as lithium-ion batteries that have been removed from vehicles, energy storage devices, personal electronic devices, and so on, which can be reused for other applications. These batteries can be considered used, previously used, preowned, “second life”, etc. The battery system can include a Battery Management System 168 (BMS) which can measure the state for each battery cell and can determine whether a battery cell is usable, available, required, etc. by the system. The battery management system can control the switches associated with the battery cells and battery columns to enable cells and columns, to bypass cells and columns, etc.

The arrangement 160 can include a communications device 170. The communication device can be remote and can be employed by a user to communicate with the battery system. The communications device can comprise a computer, laptop, tablet, cell phone, and the like. In embodiments, the communication device is another battery system, power grid, charging station, etc. which can negotiate power requirements directly with the battery system. The arrangement 160 can include a software Application Programmable Interface (API) 174. The API can include definitions and protocols to provide communication between the battery system and the communications device over an industrial grade hardware interface including industry standards such as CAN, RS-485, EtherCAT, Modbus, etc. In embodiments, the API enables an Industrial Internet of Things (IIoT) 172 capability for the battery system to enable business-to-business communications over the Internet. The API can include protocols such as Simple Object Access Protocol (SOAP), Representational State Transfer (REST), and so on. The API interface can support queries to the battery system. For example, the API interface can support a query to supply system information 176. The system information can include battery cell profiles, system status, temperature, current, voltage, power cycle information, and so on. The API software interface can provide information based on a query of capabilities 178 of the battery system. The capabilities can include features, number and health of battery cells, voltage output range, power capacity of the battery system, total energy, and so on. The API software interface can also provide information based on a query on availability of output 180 from the battery system. The availability of output query can include information on the readiness of the system, charging time required, time until a charge is needed, and so on. In cases where one of the battery cells in the battery system fails, has degrading performance characteristics, represents a safety risk, etc., the software API interface can support a command to decommission 182 a battery cell, column, portion, etc. of the battery system. The decommissioning command can disable one or more battery cells in the system. The API software interface can include the ability for a user or system to provide power request parameters 184 to the battery system. The power request parameters can include voltage, power, total energy, external system operating requirements, internal system operating requirements, user settings, or user preferences. The software API interface can include the ability to define a battery system configuration 186. The configuration can include coupling or decoupling battery cells or columns to achieve a specific energy profile. The defining of the configuration for the battery system can be based on one or more predefined configurations 190. The predefined configurations can be downloaded, edited, changed, replaced, etc. Additional configurations can be uploaded. In embodiments, the predefined configurations can include a configuration for charging, a configuration for standby, or a configuration for discharge.

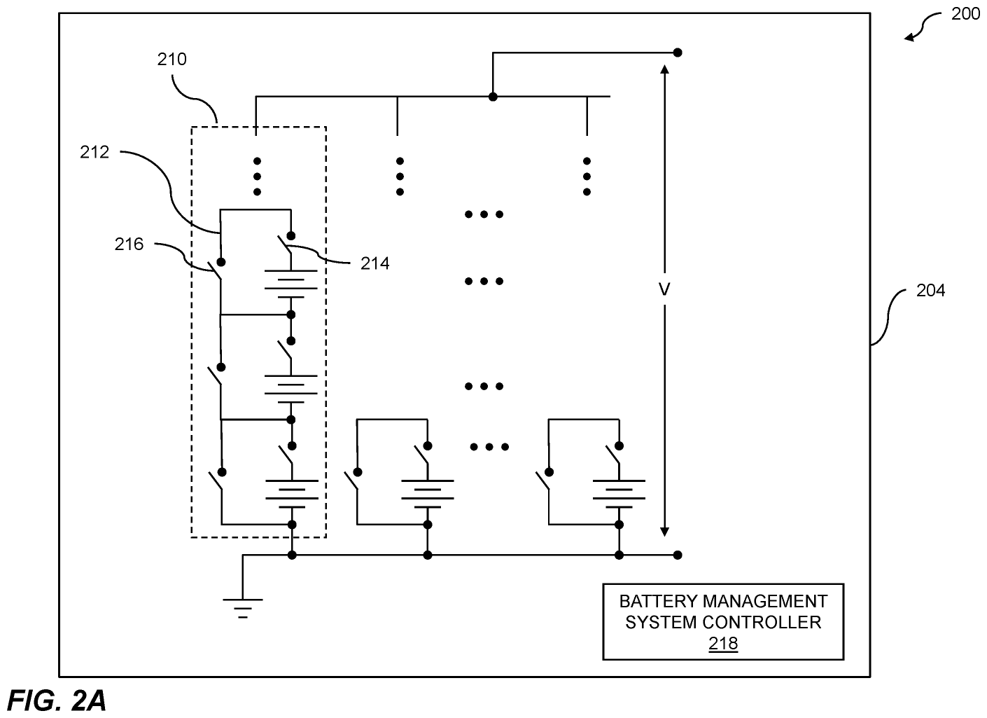

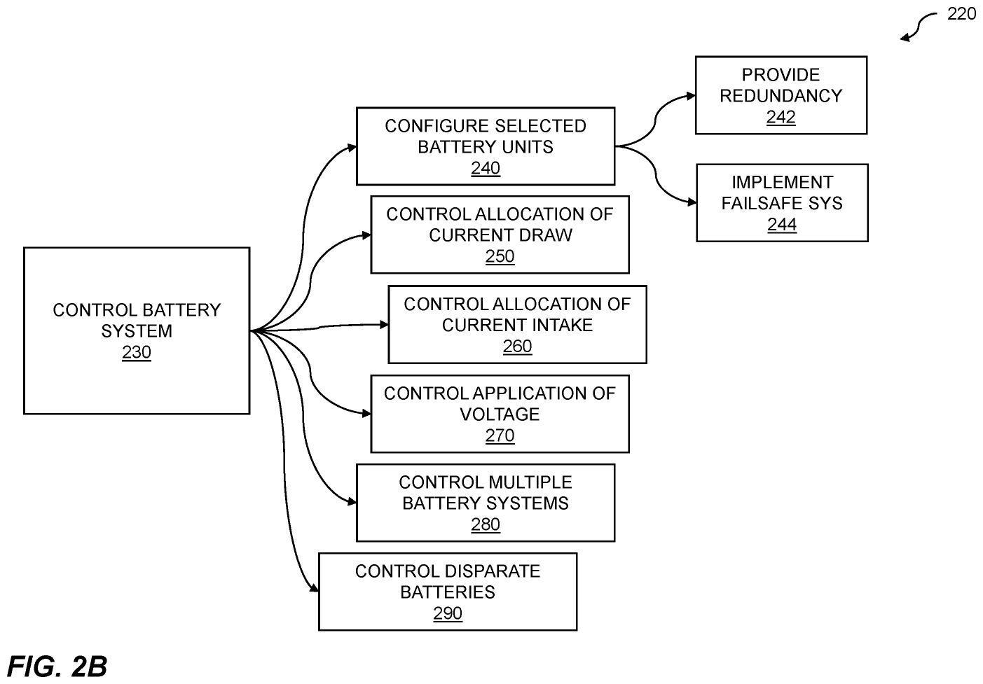

FIG. 2A illustrates columns of battery cells and switches in a battery system that can be controlled through a software interface. Discussed above and throughout, clusters of battery cells can be connected in series. These clusters can be grouped into parallel battery columns to form a battery system. An individual battery cell can be coupled to or decoupled from a battery column of which the cell is a component. Similarly, a battery column can be coupled to or decoupled from a battery system. The decoupling can be accomplished by bypassing the battery cell, the battery column, etc. The coupling and bypassing can be accomplished using high-speed, software-controlled switches such as high-speed smart switches. The smart switches enable battery system management using cell state. A state can be measured for each battery cell within the battery system. A battery index can be calculated for the battery system based on the measured state for each battery cell. Remaining energy, which can be extracted from the battery system, can be estimated based on the battery index.

A battery system comprising battery cells and switches is illustrated 200. The battery system 204 can include one or more columns of grouped battery cells such as battery column 210. The battery columns can include one or more battery cells such as battery cell 212. In embodiments, the cluster of battery cells in a battery column includes battery cells connected in series. Each battery cell within a battery column can be coupled to or decoupled from the battery column using software-controlled switches. The switches, such as switch 214 and switch 216 can accomplish coupling and decoupling respectively. In embodiments, the switches can include smart switches. A battery cell can be coupled to or grouped with other battery cells to form a battery column. Battery columns are connected in parallel within the battery system. A battery cell can be decoupled from a battery column if the battery cell is unneeded, is performing poorly, has failed, and so on. In embodiments, the decoupling can accomplish the bypassing of a battery cell. Similarly, a battery column within a battery system can be coupled to or decoupled from the battery system. As for an individual battery cell, the decoupling can accomplish bypassing a battery column. The coupling switches and the bypass switches can be controlled by a controller component of a battery management system 218. The battery management system can measure the state for each battery cell and can determine whether a battery cell is usable, available, required, etc. by the system. The battery management system can control the switches associated with the battery cells and battery columns to enable cells and columns, to bypass cells and columns, etc. The battery cells within the battery columns can produce a voltage V of, for example, 220V. The voltage can be based on increments of voltage, where an increment of voltage can be determined by a voltage associated with a battery cell.

FIG. 2B is a flow diagram for battery system control using a software interface. Batteries included within a disparate battery system can be controlled. Rechargeable batteries such as lithium-ion batteries that have been removed from vehicles, energy storage devices, personal electronic devices, and so on can be reused for other applications. These second use batteries can be perfectly capable of functioning in certain capacities and usages. While the batteries may no longer meet their original specifications with respect to energy storage, leakage, and so on, the batteries can still store and provide energy. In order to use such “second life” batteries, the batteries can be disassembled down to their battery cells. Software-controlled switches and scanners or sensors can be coupled to the battery cells. The switches can be used to couple, decouple, and bypass the battery cells, while the scanners and sensors can be used to monitor battery performance information such as temperature, temperature rate-of-change, current, voltage, voltage rate-of-change, or impedance data. The switches, which are based on high-speed switching devices, and the scanners can be controlled in order to operate the battery cells, battery units, and battery systems at their most efficient and safest levels. The safe battery levels can be monitored by a failsafe system that monitors safe battery levels and selectively disconnects battery units from the battery system before a battery unit failure. The battery cells, units, and systems can be monitored frequently to quickly respond to any detected problems. The monitoring and response enable dynamic control.

The flow 220 includes controlling the battery system 230. The controlling the battery system can include scanning battery units, where battery units contain one or more battery cells. The control can further include analyzing battery units to determine usability and capacity of the battery units. The controlling can include coupling or decoupling battery cells within battery units to the battery units, coupling or decoupling battery units within a battery system, coupling or decoupling battery systems within a plurality of battery systems, and so on. The controlling can collect battery unit performance information from the battery units. In the flow 220, the controlling the battery system can configure 240 selected battery units. Selected battery units can include battery units that have been identified based on the analyzing to have sufficient usability and capacity, such as storage capacity, to be used within a battery system. In the flow 220, the configuring the selected battery units provides redundancy 242 for the battery system. The redundancy can be based on storage capacity, battery system reliability, a backup power requirement, a safety factor, and so on. In embodiments, redundancy can be accomplished using an extra number of battery units in a column of battery units. The extra battery units can be switched in as needed to replace exhausted battery units, failed battery units, etc. In embodiments, the redundancy can provide for maintaining capacity. Capacity, such as storage capacity, can be maintained by switching in additional battery units as needed. Battery units can be switched in, switched out, bypassed, and so on. In other embodiments, the redundancy can provide for increasing reliability of the battery system. The redundancy can be based on N+1 redundancy, where N is the number of battery units required by a battery system plus one spare. The spare can be switched in as needed. Another redundancy scheme can include 2N redundancy. The flow 220 can include implementing a “failsafe” system 244. The failsafe system can be used to protect the battery system from over-voltage or over-current conditions, from thermal events such as thermal runaway, and the like. In embodiments, the failsafe system can monitor safe battery levels and can selectively disconnect battery units from the battery system before a battery unit failure. Depending on a battery technology, battery unit failure can be catastrophic, resulting in fire or explosion (spontaneous eruption of battery cells). The failsafe system can operate by monitoring battery levels. In embodiments, the safe battery levels can be based on voltage, current, or temperature. The safe battery levels can include expected levels, nominal levels, target levels, and so on. The failsafe system can adapt. In embodiments, monitoring with the failsafe system can be based on machine learning. Battery units with the battery system that are identified as problematic can be bypassed or removed. In embodiments, a battery unit within the plurality of battery units can be hot-swappable. Some embodiments comprise implementing a failsafe system using the battery units. In embodiments, the failsafe system monitors safe battery cell levels and selectively disconnects battery units from the battery system before a battery unit failure.

In the flow 220, the controlling the battery system controls allocation 250 of current draw from a subset of battery units from the plurality of battery units during a discharge event. The discharge event can include providing current to one or more loads. The discharge event can be based on providing constant voltage or constant current. In other embodiments, a discharge event can include a safety discharge event. A safety discharge event can occur when a battery cell or battery unit has failed, overheated, etc. The battery unit or cell can be safely discharged in order to avoid risk of fire or explosion in the battery unit or cell. In the flow 220, the controlling the battery system controls the allocation of current intake 260 to a subset of battery units from the plurality of battery units during a charge event. Current intake can be associated with charging battery cells, battery units, and a battery system. The charging of batteries can be based on providing constant current, variable current, constant voltage, variable voltage, etc. In embodiments, the battery system controls application of voltage 270 coupled to the subset of battery units from the plurality of battery units during a charge event. A technique used for charging of batteries can be selected based on battery type. In the flow 220, the battery system further comprises controlling multiple connected battery systems 280. The multiple connected battery systems can be controlled by connecting or disconnecting one or more battery systems to maintain capacity, to provide redundancy, etc.

In the flow 220, the controlling the battery system controls disparate batteries 290. While disparate batteries can include different performance characteristics for a given battery type, such as lithium-ion batteries from different manufacturers, with different performance characteristics, with different aging and use profiles, etc., disparate batteries can also include different battery types, such as mixing lithium-ion batteries with lithium-metal batteries or mixing lithium-ion batteries with sodium-ion batteries in a battery system. The mixing can include both serial connections and parallel connections of disparate batteries and disparate battery types. In embodiments, the battery system is comprised of disparate battery types. Various steps in the flow 220 may be changed in order, repeated, omitted, or the like without departing from the disclosed concepts. Various embodiments of the flow 220 can be included in a computer program product embodied in a non-transitory computer readable medium that includes code executable by one or more processors.

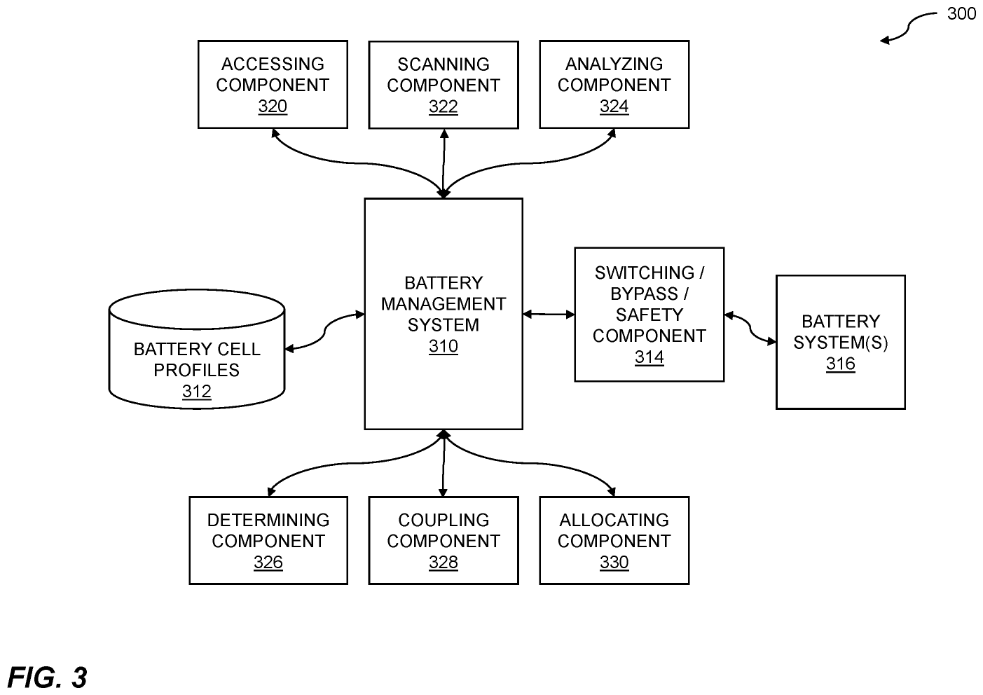

FIG. 3 is a system block diagram for battery system management using a software interface. Dynamic battery control within a battery system can be accomplished at the battery cell level. This fine level of control is based on determining performance information associated with the battery cells, continually monitoring the battery cells for present voltage and charge states, for cell health, and so on. The dynamic battery control enables a battery system to deliver a configured voltage, current, and the like. The dynamic battery control enables control of a disparate battery system. A plurality of battery units is accessed, wherein the battery units contain one or more battery cells, wherein the battery cells may have a variety of profiles. Battery units within the plurality of battery units are scanned to collect performance information. The battery units are analyzed to determine usability and capacity based on the performance information. A battery system configuration is determined based on the analyzing. Battery units within the plurality of battery units are coupled to form a battery system, wherein the coupling is accomplished by switching based on the determining.

The system block diagram 300 includes a Battery Management System 310 (BMS). The BMS can initiate scanning of battery units to determine one or more profiles for one or more battery cells within a battery unit. The battery system controller can further analyze the battery units to determine whether a battery unit is usable for a given battery application, to determine the capacity of the battery unit to obtain and retain a charge, to ascertain the capacity of the battery to provide current, etc. The BMS can be used to configure a battery system. In embodiments, the controlling the battery system can configure selected battery units to provide redundancy for the battery system. The redundancy can be used to increase battery uptime, to improve safety, etc. The BMS can be used to swap out battery units. In embodiments, a battery unit within the plurality of battery units can be hot-swappable. The system block diagram includes battery cell profiles 312. The battery cell profiles can include a wide range of information associated with one or more of the battery units being used. In embodiments, the battery cell profiles can include usability and remaining capacity for battery units within the plurality of battery units. The usability information associated with the battery profile can be used to determine whether a battery unit can be chosen for inclusion within a battery system. The battery capacity can be used to determine how much current a battery element can provide, whether the battery unit requires recharging, whether the battery unit should be swapped out, etc. In embodiments, the battery profiles can be updated on any regular time interval. The regular time interval can be determined based on a safety factor such as rapid detection of an overheating battery cell to prevent fire or explosion. In embodiments, the building the profiles is accomplished using statistical analysis. In embodiments, the building the profiles is accomplished using machine learning.

The system block diagram 300 includes a switching, bypass, and safety (SBS) component 314. The SBS component can couple or decouple battery systems, battery units, battery cells, and so on. The SBS component can further enable bypassing of a battery system, one or more battery units with a system, one or more battery cells within a battery unit, etc. The SBS can be used to accomplish a failsafe system associated with the battery system. In embodiments, the failsafe system can monitor safe battery levels and can selectively disconnect battery units from the battery system before a battery unit failure. Levels associated with a battery system can be monitored by the battery system controller. In embodiments, the safe battery levels can be based on voltage, current, or temperature. The battery levels can further be based on battery impedance. In a usage example, a battery with an impedance less than a nominal impedance can be nearing failure. Thus, the low impedance or short circuit can be detected, and the offending battery unit or battery cell can be switched out quickly. In embodiments, the failsafe system can be based on machine learning. The system block diagram includes one or more battery systems 316. The one or more battery systems can be configured to provide a voltage, an amount of current, a storage capacity, and the like. When more than one battery system is configured, the battery systems can be configured with redundancy. Discussed previously, a battery system can be formed by coupling battery cells.

The BMS 310 can be coupled to one or more components that can perform operations, obtain data, and so on. The block diagram 300 can include an accessing component 320. The accessing component can access a plurality of battery units. The battery units can be based on rechargeable batteries such as lithium-ion batteries. The battery units can contain one or more battery cells, where the battery cells may have a variety of profiles. The battery profiles can be built using machine learning. The battery profiles can include details about a given battery unit. In embodiments, the battery profiles can include usability and remaining capacity for battery units within the plurality of battery units. The battery profiles are not static, but rather can be updated on any regular time interval. The time interval can include a few milliseconds, seconds, etc. In embodiments, the profiles include information on one or more of the battery units being used.

The system block diagram 300 includes a scanning component 322. The scanning component can scan battery units within the plurality of battery units. The scanning can be used to collect performance information associated with the battery units. The performance information can include various types of data associated with the battery units. In embodiments, the performance information can include temperature, temperature rate-of-change, current, voltage, voltage rate-of-change, or impedance data. The performance data can be collected prior to configuring a battery system, while a battery system is in use, and so on. In embodiments, the performance information can be collected in real time. The system block diagram 300 includes an analyzing component 324. The analyzing component can be used to analyze the battery units to determine usability and capacity based on the performance information. The usability and capacity data can be included in the battery profiles. The usability can include whether a battery unit is available for configuration in a battery system, whether the battery unit has physical integrity, etc. The capacity of a battery unit can include remaining capacity. The remaining capacity can be based on a percentage, a value, a threshold, and so on.

The system block diagram 300 includes a determining component 326. The determining component can be used to determine a battery system configuration based on the analyzing. The battery system configuration can be based on a quantity of battery units; a required voltage, current, and storage capacity; a required redundancy level; a safety margin; and so on. In embodiments, the determining the battery system configuration can be further based on profiles of the battery cells. The system block diagram 300 includes a coupling component 328. The coupling component can be used to couple battery units within the plurality of battery units to form a battery system, wherein the coupling is accomplished by switching based on the determining. In embodiments, fast-switching technology can be used to connect or disconnect one or more of battery units from the battery system. The switching technology can further be used to bypass one or more battery cells, battery units, and so on. In embodiments, the fast-switching technology can include isolated-gate transistor technology. The system block diagram 300 can include an allocating component 330. The allocating can include allocation of current, allocation of voltage, and so on. The allocating can be based on the controlling. In embodiments, the controlling the battery system can control allocation of current draw from a subset of battery units from the plurality of battery units during a discharge event. A discharge event can include normal operation of the battery system where current can be provided to one or more loads. The discharge event can also occur due to a battery failure, overheating, etc. In embodiments, a discharge event can include a safety discharge event. A battery can be safely discharged in order to prevent or reduce the risk of battery explosion, the battery catching fire, and so on. In other embodiments, the controlling the battery system can control the allocation of current intake to a subset of battery units from the plurality of battery units during a charge event. The controlling the current intake can be based on the type of rechargeable batteries that are to be recharged.

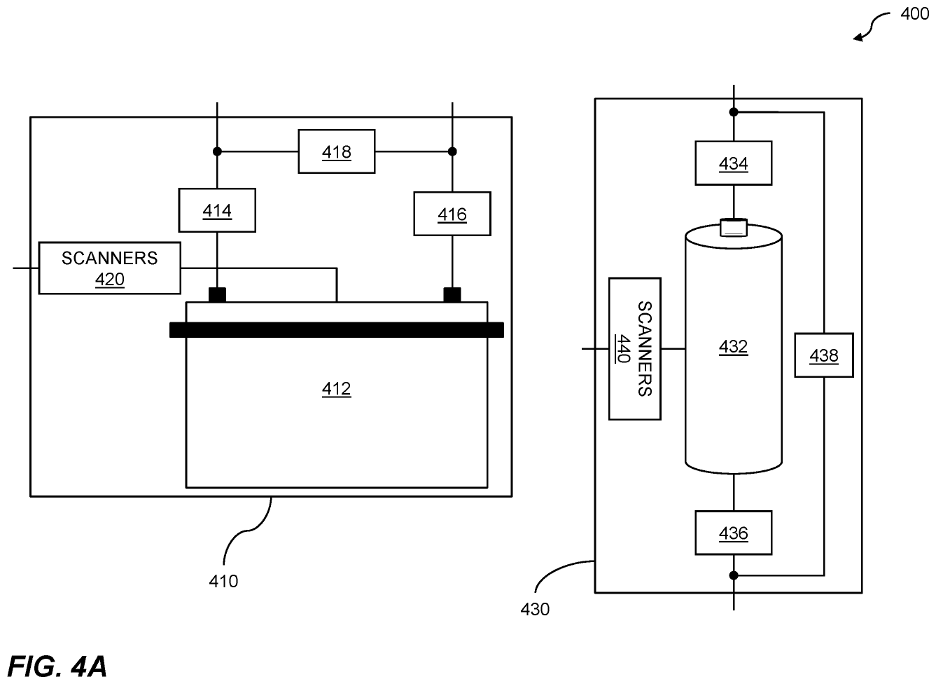

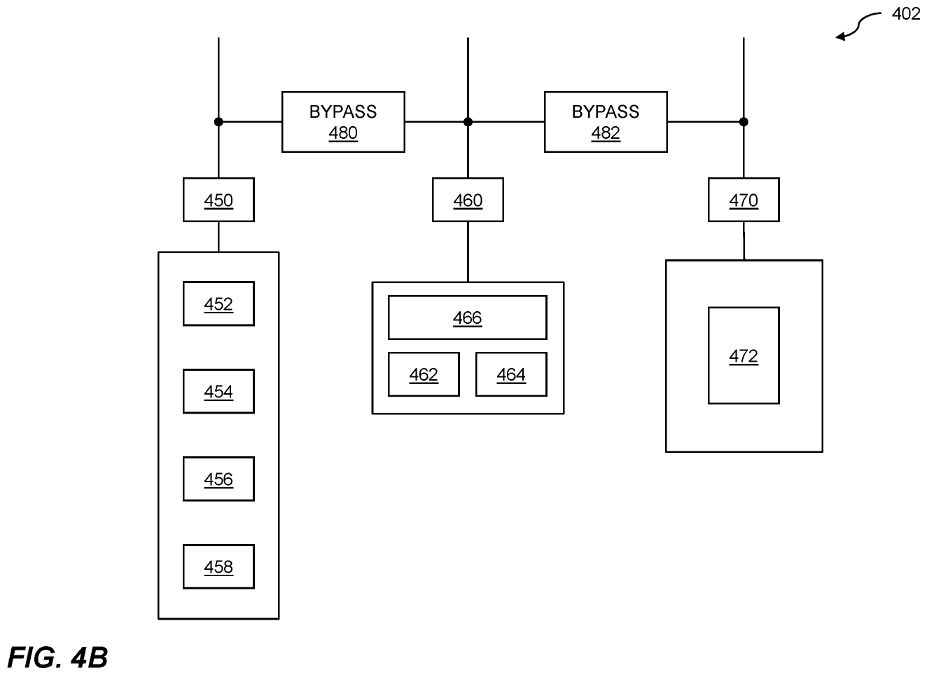

FIG. 4A illustrates example battery units that can be accessed as part of a software-defined energy storage system. One or more battery units, each of which can comprise one or more battery cells, can be used as building blocks for a battery system configuration. A battery unit can further include software-controlled switches, sensors, monitors, and so on. The switches and sensors can be used to select, bypass, and control a battery unit; to monitor the condition and health of a battery unit; and so on. The switching and sensing of the battery unit enables dynamic control of a disparate battery system. A plurality of battery units is accessed, wherein the battery units contain one or more battery cells, wherein the battery cells may have a variety of profiles. Battery units within the plurality of battery units are scanned to collect performance information. The battery units are analyzed to determine usability and capacity based on the performance information. A battery system configuration is determined based on the analyzing. Battery units within the plurality of battery units are coupled to form a battery system, wherein the coupling is accomplished by switching based on the determining.

Two example battery unit configurations are illustrated 400. A battery unit configuration 410 shows a battery 412 with top-mounted terminals. The top-mounted terminals can include binding posts, lugs, bolts, screws, etc. The battery 412 can be coupled to one or more switches, such as switches 414 and 416. In some configurations, one of the switches 414 or 416 may be eliminated to enable a common ground, a common positive, and so on. The battery unit configuration 410 can include a bypass switch such as switch 418. The bypass switch can be used to bypass the battery 412. The bypassing of the battery can be used to swap out a battery, to eliminate a failed or overheated battery, etc. The battery unit configuration 410 can further include one or more scanners 420. The one or more scanners, which can be based on one or more sensors, can determine one or more levels associated with the battery 412. The levels associated with the battery 412 can include safe battery levels. In embodiments, the safe battery levels can be based on voltage, current, temperature, open circuit voltage, battery cell impedance, etc. The scanners can include standalone components or can be incorporated into one or more other components associated with the battery unit. In embodiments, the scanners can be colocated with the bypass switch 418. A second battery unit configuration 430 is shown. The second battery unit configuration shows a battery 432 with a different terminal configuration from that of the first battery 412. The second battery unit configuration can further include selection switches 434 and 436, and a bypass switch 438. The battery unit configuration 430 can additionally include scanners 440. As was the case for the scanners and bypass switch associated with the first battery unit configuration 410, in embodiments, the scanners 440 can be colocated with the bypass switch 438.

FIG. 4B illustrates multiple battery unit configurations that are part of a software-defined energy storage system. A battery unit can include one or more battery cells, where the cells can include cells with varying terminal configurations, sizes, weights, and so on. The battery cells within a battery unit can include a substantially similar battery type. In embodiments, the one or more battery cells can include lithium-ion battery cells. Other battery types that can be used within a battery unit can include sealed lead-acid (SLA), nickel-cadmium (NiCd), nickel-metal hydride (NiMH), lithium-polymer (LiPo), lithium-iron-phosphate (LiFePO4), sodium-ion (Na-ion), lithium-metal, etc. The battery cells within a battery unit can be selected, bypassed, etc. using one or more switches. The multiple battery unit configurations enable dynamic control of a disparate battery system. Multiple battery unit configurations are shown 402, where one or more battery units can be configured to form a battery system. The multiple battery units can include switches associated with battery cells. The battery units can include a switch 450 associated with battery cells 452, 454, 456, and 458; a switch 460 associated with battery cells 462, 464, and 466; a switch 470 associated with battery cell 472, and so on. A battery unit can be bypassed using one or more bypass switches such as bypass switch 480 and bypass switch 482.

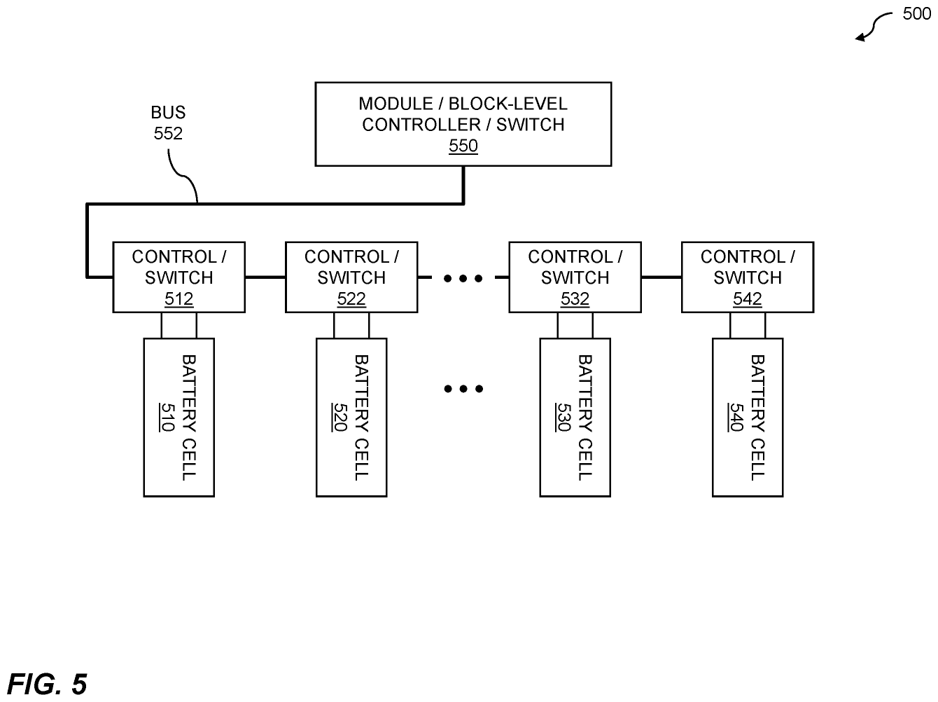

FIG. 5 is a system schematic diagram for battery management as part of a software-defined energy storage system. Described above and throughout, a plurality of battery cells can be connected in series by a plurality of software-controlled switches comprising a plurality of battery columns. The columns can be connected in parallel using the software-controlled switches forming the battery system. The battery system can be controlled to couple and decouple battery units, to charge the battery units, to control discharge of the battery units, and so on. The coupling and decoupling of the battery units is accomplished by switching that is controlled by battery management. The battery management enables dynamic control of a disparate battery system. A plurality of battery units is accessed, wherein the battery units contain one or more battery cells, wherein the battery cells may have a variety of profiles. Battery units within the plurality of battery units are scanned to collect performance information. The battery units are analyzed to determine usability and capacity based on the performance information. A battery system configuration is determined based on the analyzing. Battery units within the plurality of battery units are coupled to form a battery system, wherein the coupling is accomplished by switching based on the determining.

The system block diagram 500 includes a battery cell 510. The battery cell can be associated with one of a variety of profiles, where the profiles can include usability, remaining capacity, and so on. The battery cell can be associated with a type of rechargeable battery. In embodiments, the battery cell can include a lithium-ion battery. Other types of rechargeable batteries can include sealed lead-acid (SLA), nickel-cadmium (NiCd), nickel-metal hydride (NiMH), lithium-polymer (LiPo), lithium-iron-phosphate (LiFePO4), sodium-ion, lithium-metal, etc. One or more battery cells can be coupled together to form a battery unit. A battery cell can further be characterized based on voltage, energy storage, size, weight, terminal configuration, and the like. The system block diagram includes a control and switch component 512. The control and switch component can be used to control access to the battery cell to enable charging of the cell and discharging of the cell (e.g., using the cell to provide current). The control and switch component can couple the battery cell to a battery unit, can decouple the battery cell from the battery unit, etc. The control and switch component can further include one or more sensors. The sensors can include current, voltage, temperature, and impedance sensors. The control and switch component can be used to bypass a battery cell if the cell is unneeded, has failed, has overheated, etc. The system block diagram 500 can include further battery cells and further control and switch components such as battery cell 520 and control and switch component 522; battery cell 530 and control and switch component 532; and battery cell 540 and control and switch component 542.

The system block diagram includes a module/block-level controller and switch 550. The module/block-level controller and switch (MBCS) can select which battery cells can be included in a battery unit, can bypass one or more battery cells, and the like. The battery cells and their associated controller/switches can be configured in arrays comprising one or more rows, one or more columns, etc. The MBCS can communicate with the one or more battery cells and associated controllers using a bus 552. One or more battery units can be configured to form a battery system. In embodiments, the controlling the battery system can configure selected battery units to provide redundancy for the battery system. The redundancy can be based on providing additional battery cells, battery units, battery systems, etc. In embodiments, the redundancy can be accomplished using an extra number of battery units in a column of battery units. Recall that one or more battery cells can be coupled or decoupled from a battery unit. Battery cells can further be bypassed. Further embodiments include bypassing one or more battery units in the column based on the extra number. The bypassing can be accomplished using fast-switching technology to connect or disconnect one or more of battery units from the battery system. In embodiments, the fast-switching technology can include isolated-gate transistor technology.

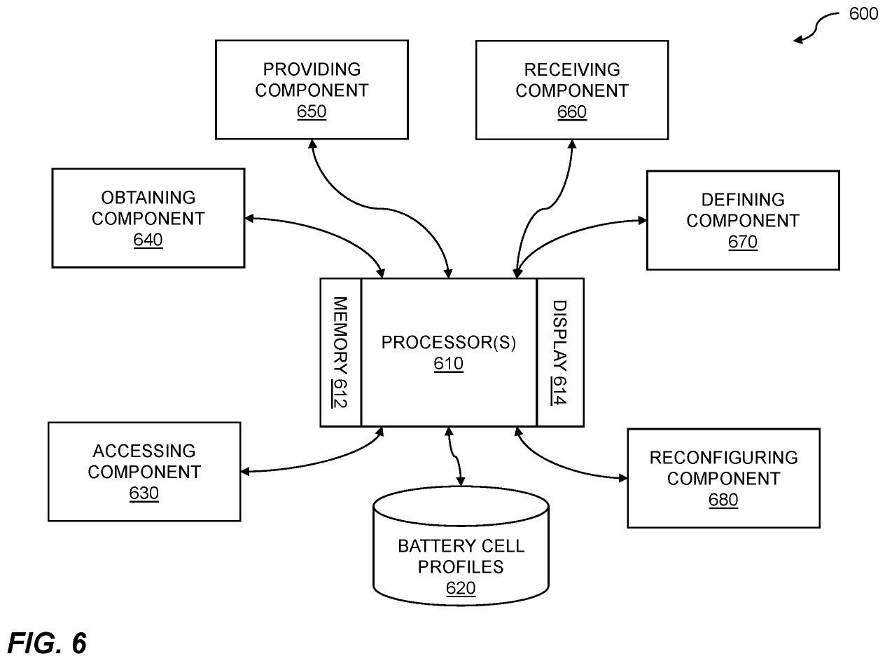

FIG. 6 is a system diagram for control of a software-defined energy storage system. The battery management is enabled by dynamic control of a disparate battery system. The system 600 can include one or more processors 610, which are attached to a memory 612 which stores instructions. The system 600 can further include a display 614 coupled to the one or more processors 610 for displaying data, intermediate steps, performance information, battery usability and capacity data, and so on. In embodiments, one or more processors 610 are coupled to the memory 612, wherein the one or more processors, when executing the instructions which are stored, are configured to: access a battery system comprising a plurality of battery cells, wherein the plurality of battery cells and a plurality of software-controlled switches comprise a plurality of battery columns made up of battery cells arranged in series using the software-controlled switches, wherein the plurality of battery columns is connected in parallel using the software-controlled switches; obtain information on the battery system; provide the information on the battery system through a software interface; receive a set of power request parameters through the software interface; define a configuration for the battery system based on the power request parameters and the information on the battery system; and reconfigure the battery system, based on the configuration for the battery system that was defined. The batteries can include a variety of rechargeable batteries such as sealed lead-acid (SLA), nickel-cadmium (NiCd), nickel-metal hydride (NiMH), lithium-ion (Li-ion), lithium-polymer (LiPo), lithium-iron-phosphate (LiFePO4), etc.

The system 600 can include battery cell profiles 620. The battery cell profiles 620 can be used to store data associated with batteries that can form the battery system. The battery cell profiles can include physical parameters associated with the batteries, such as size, shape, weight, terminal configuration, battery chemical type, safety information, and so on. The battery cell profiles can further include battery manufacturer, manufacture date, in-service date, removed from primary service date, charge/discharge count, and the like. The battery cell profiles can include battery cell performance information (described below), battery usability, etc. In embodiments, the performance information can be collected in real time. The performance data can be collected during battery selection, battery usage, and so on. In embodiments, the performance information can include temperature, temperature rate-of-change, current, voltage, voltage rate-of-change, or impedance data. The performance information can be used to determine battery unit overheating, a short-circuit condition, etc. Further embodiments can include implementing a failsafe system. The failsafe system can protect a battery unit from fire, explosion (spontaneous eruption), and so on. In embodiments, the failsafe system can monitor safe battery levels and can selectively disconnect battery units from the battery system before a battery unit failure. The disconnected battery unit can be swapped out. In embodiments, a battery unit within the plurality of battery units is hot-swappable. One or more battery units can be swapped out without having to shut down a battery system prior to battery unit swap. In embodiments, the safe battery levels can be based on voltage, current, temperature, smoke sensor, particle sensor, etc. Battery safety levels can also be based on battery unit impedance such as a typical impedance, a low impedance or “short circuit” event, etc. In other embodiments, monitoring with the failsafe system is based on machine learning. The machine learning can detect anomalous battery operation, predict mean time to failure (MTTF), and so on.

The system 600 can include an accessing component 630. The accessing component can include functions and instructions to access a battery system comprising a plurality of battery cells, wherein the plurality of battery cells and a plurality of software-controlled switches comprise a plurality of battery columns made up of battery cells arranged in series using the software-controlled switches, and wherein the plurality of battery columns is connected in parallel using the software-controlled switches. The battery units can include units replaced as part of routine maintenance of vehicles such as electric vehicles, battery units recovered from consumer electronics, and so on. The battery units can include units of different sizes, types, weights, energy densities, voltages, and the like. In embodiments, the profiles can include information on aging, brand, specification, and so on.

The system 600 can include an obtaining component 640. The obtaining component can include functions and instructions for obtaining information on the battery system. The obtaining information can include scanning the battery cells to read the battery profiles to collect performance information such as temperature, current, voltage, impedance, number of cycles, and so on. The performance information can be evaluated at various levels including a battery cell, a battery column, the battery system, etc., and can be collected while the battery cells, columns, system, etc. is in use. The performance information can be read from, downloaded with, uploaded to, etc. to the battery cell profiles. In embodiments, the information can be collected at start up and in real time.

The system 600 can include a providing component 650. The providing component can include functions and instructions to provide the information on the battery system through a software interface. The software interface can include an Application Programmable Interface (API). The software API can include definitions and protocols to provide communication to and from the battery system over an industrial grade hardware interface such as CAN, RS-485, EtherCAT, Modbus, etc. The API can also enable an Industrial Internet of Things (IIoT) capability for the battery system. The API interface can support queries of the battery system to supply information such as battery cell profiles; system status; performance information such as temperature, voltage, and power cycle information; capabilities of the system such as total energy available or voltage output range; rate-of-change of performance information; and availability of output such as readiness of the system, charging time required, etc. Providing the information on the battery system can be associated with a cost for users or external systems to decide on an appropriate power request.

The system 600 can include a receiving component 660. The receiving component can include functions and instructions to receive a set of power request parameters through the software interface. The software API interface can receive power requests from a user. Requests can also be made through the API by other external systems requiring power such as power grids, buildings, such as a condominium complex or a strip mall, charging stations, other battery systems, and so on. The power requirements can include parameters such as voltage, power, total energy, external system operating requirements, internal system operating requirements, user settings, or user preferences. In embodiments, the power request parameters include changing the direction of current flow to charge or discharge the battery cells, columns, system, etc.; changing the voltage output of the system; balancing energy storage between multiple battery systems; responding to a power grid demand; and so on.

The system 600 can include a defining component 670. The defining component can include functions and instructions to define a configuration for the battery system based on the power request parameters. The configuration of battery cells and columns within the system can be controlled by the system, user, etc., to achieve the power request parameters and achieve a specific energy profile. The defining can use a battery management system to determine a configuration based on the power request parameters. The defining of the configuration for the battery system can be based on one or more predefined configurations. Adjustments to the configuration can be accomplished dynamically. The system configuration can include an inverter to convert the DC voltage associated with the battery system to AC voltage. In some embodiments, the system configuration can include a DC-to-DC converter.

The system 600 can include a reconfiguring component 680. The reconfiguring component can include functions and instructions to reconfigure the battery system, using the software-controlled switches within the battery system, based on the configuration for the battery system that was defined. The reconfiguring can be accomplished by the plurality of software-controlled switches within the battery system. The reconfiguring can include setting the switches for a different voltage arrangement for charging than a voltage arrangement for discharging. For example, the voltage can be adjusted down for charging to 40V, 50V, and so on. Likewise, the battery system voltage for providing energy can be adjusted to 600V, 800V, 1000V, and so on. The reconfiguring can be accomplished dynamically. A built-in electrical design to smooth voltage and current spikes can be provided within the software-controlled switches to avoid damage to appliances as the configuration is changed on the fly. The reconfiguration can be based on negotiating subsequent power parameters based on the set of power request parameters received and the information on the battery system. The negotiating can be accomplished dynamically during run time. The negotiating can be based on a target voltage, current, duration, safety factors, a predefined voltage, and so on. The negotiating can be in response to changes in battery unit voltages as the battery units discharge, changing energy requirements of the requesting system, etc.

The system 600 can include a computer program product embodied in a non-transitory computer readable medium for battery management, the computer program product comprising code which causes one or more processors to perform operations of: accessing a battery system comprising a plurality of battery cells, wherein the plurality of battery cells and a plurality of software-controlled switches comprise a plurality of battery columns made up of battery cells arranged in series using the software-controlled switches, wherein the plurality of battery columns is connected in parallel using the software-controlled switches; obtaining information on the battery system; providing the information on the battery system through a software interface; receiving a set of power request parameters through the software interface; defining a configuration for the battery system based on the power request parameters and the information on the battery system; and reconfiguring the battery system, based on the configuration for the battery system that was defined.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for energy storage comprising:
accessing a battery system comprising a plurality of battery cells, wherein the plurality of battery cells and a plurality of software-controlled switches comprise a plurality of battery columns made up of battery cells arranged in series using the software-controlled switches, wherein the plurality of battery columns is connected in parallel using the software-controlled switches;
obtaining information on the battery system;
providing the information on the battery system through a software interface;
receiving a set of power request parameters through the software interface;
defining a configuration for the battery system based on the power request parameters and the information on the battery system; and
reconfiguring the battery system, based on the configuration for the battery system that was defined.

2. The method of claim 1 wherein the reconfiguring is accomplished using the software-controlled switches within the battery system.

3. The method of claim 1 wherein the information on the battery system is based on battery cell profiles.

4. The method of claim 3 wherein the battery cell profiles reflect disparate battery cell performance.

5. The method of claim 1 further comprising reobtaining information on the battery system periodically.

6. The method of claim 5 wherein the information that was reobtained enables dynamic reconfiguring of the battery system.

7. The method of claim 1 wherein the software interface comprises an application program interface (API).

8. The method of claim 1 wherein the plurality of software-controlled switches comprises a crossbar switch.

9. The method of claim 1 wherein the providing of the information on the battery system through the software interface is based on receiving a query on availability of output from the battery system through the software interface.

10. The method of claim 1 wherein the power request parameters include voltage, power, total energy, external system operating requirements, internal system operating requirements, user settings, user preferences, or cost.

11. The method of claim 1 further comprising negotiating, using one or more processors, a subsequent set of power parameters based on the set of power request parameters received and the information on the battery system.

12. The method of claim 11 wherein the negotiating is accomplished during run time.

13. The method of claim 1 further comprising decommissioning a portion of the battery system using the software interface to the battery system.

14. The method of claim 1 wherein the providing the information on the battery system is accomplished using secure TCP/IP protocols.

15. The method of claim 1 wherein the defining the configuration for the battery system is based on one or more predefined configurations.

16. The method of claim 15 wherein the one or more predefined configurations include a configuration for charging, a configuration for standby, or a configuration for discharge.

17. The method of claim 1 wherein the software interface includes CAN, RS-485, EtherCAT, or Modbus.

18. The method of claim 1 wherein the reconfiguring the battery system includes a different voltage arrangement for charging the battery system from a voltage arrangement for discharging the battery system.

19. The method of claim 1 wherein the plurality of battery cells is grouped into battery units.

20. The method of claim 19 further comprising implementing a failsafe system using the battery units.

21. The method of claim 20 wherein the failsafe system monitors safe battery cell levels and selectively disconnects battery units from the battery system before a battery unit failure.

22. The method of claim 1 wherein the battery system is comprised of disparate battery types.

23. A computer program product embodied in a non-transitory computer readable medium for battery management, the computer program product comprising code which causes one or more processors to perform operations of:
accessing a battery system comprising a plurality of battery cells, wherein the plurality of battery cells and a plurality of software-controlled switches comprise a plurality of battery columns made up of battery cells arranged in series using the software-controlled switches, wherein the plurality of battery columns is connected in parallel using the software-controlled switches;
obtaining information on the battery system;
providing the information on the battery system through a software interface;
receiving a set of power request parameters through the software interface;
defining a configuration for the battery system based on the power request parameters and the information on the battery system; and
reconfiguring the battery system, based on the configuration for the battery system that was defined.

24. A computer system for task processing comprising:
a memory which stores instructions;
one or more processors coupled to the memory, wherein the one or more processors, when executing the instructions which are stored, are configured to:
access a battery system comprising a plurality of battery cells, wherein the plurality of battery cells and a plurality of software-controlled switches comprise a plurality of battery columns made up of battery cells arranged in series using the software-controlled switches, wherein the plurality of battery columns is connected in parallel using the software-controlled switches;
obtain information on the battery system;
provide the information on the battery system through a software interface;
receive a set of power request parameters through the software interface;
define a configuration for the battery system based on the power request parameters and the information on the battery system; and
reconfigure the battery system, based on the configuration for the battery system that was defined.
